(19) United States
(12) Patent Application Publication
(10) Pub. No.: US 2017/0140301 A1
(43) Pub. Date: May 18, 2017

(54) IDENTIFYING SOCIAL BUSINESS CHARACTERISTIC USER

(71) Applicant: Alibaba Group Holding Limited, Grand Cayman (KY)

(72) Inventors: Zhou Ye, Hangzhou (CN); Yu Wang, Hangzhou (CN); Fan Chen, Hangzhou (CN); Yang Yang, Hangzhou (CN); Qingkai Mao, Hangzhou (CN); Nannan Du, Hangzhou (CN); Hui Wang, Hangzhou (CN); Fangxue Du, Hangzhou (CN); Fei Yuan, Hangzhou (CN)

(21) Appl. No.: 15/353,601

(22) Filed: Nov. 16, 2016

(30) Foreign Application Priority Data
Nov. 16, 2015 (CN) 201510784634.5

(51) Int. Cl. G06N 99/00; G06Q 50/00; G06F 17/30

(52) U.S. Cl. CPC G06N 99/005; G06F 17/30598; G06F 17/30554; G06Q 50/01; H04L 51/32

(57) ABSTRACT

A method includes acquiring user data of candidate users; mining a social business characteristic user in some of the candidate users according to the first social attribute data; training a classifier by using second social attribute data and second business object attribute data of the social business characteristic user; and inputting first social attribute data and first business object attribute data of a neighboring user to the classifier, and outputting a result of whether the neighboring user, in a period of time after the first period of time, is a social business characteristic user, wherein the neighboring user is a candidate user other than the social business characteristic user. The present disclosure increases the volume of associated data, and improves the accuracy of the classifier, thus improving the accuracy of identification, so that potential social business characteristic users in the first period of time can be identified.

### CROSS-REFERENCE TO RELATED APPLICATION

The present disclosure claims the benefit of Chinese Patent Application Number 201510784634.5 filed Nov. 16, 2015, entitled “Method and Apparatus for Identifying Social Business Characteristic User” which is hereby incorporated by reference in its entirety.

### TECHNICAL FIELD

The present disclosure relates to the technical field of computers, and, more particularly, to a method for identifying a social business characteristic user and a device for identifying a social business characteristic user.

### BACKGROUND

The rapid development of networks has brought people into an information society and a network economy era, thereby producing a profound impact on the development of enterprises and personal life.

In order to improve the accuracy of services, many websites identify users, and serve users in a group according to characteristics of the group.

For example, users in a sports-loving group are provided with the latest sports news, users in an animation-loving group are provided with the latest animation information, and so on.

At present, user identification is generally carried out by clustering users with similar behaviors into the same group according to the similarity between user behaviors.

On one hand, these user identification methods only use one type of behavior data for clustering. There is a small volume of data and the behavior is one-sided.

On the other hand, these user identification methods only focus on the current period of time, while the user behavior is changing over time.

These user identification methods have low identification accuracy, and cannot identify some potential users.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

In view of the above problems, the example embodiments of the present disclosure provide a method for identifying a social business characteristic user and a corresponding device for identifying a social business characteristic user, to overcome the above problems or at least partially overcome the above problems.

To solve the above problems, the example embodiments of the present disclosure disclose a method for identifying a social business characteristic user, which includes:

acquiring user data of candidate users, wherein the user data includes first social attribute data and first business object attribute data associated in a first period of time, and second social attribute data and second business object attribute data associated in a second period of time, and the second period of time is in a period of time prior to the first period of time;

mining a social business characteristic user in at least some of the candidate users according to the first social attribute data;

training a classifier by using the second social attribute data and the second business object attribute data of the social business characteristic user; and

inputting first social attribute data and first business object attribute data of a neighboring user to the classifier, and outputting a result of whether the neighboring user, in a period of time after the first period of time, is a social business characteristic user, wherein the neighboring user is a candidate user other than the social business characteristic user.

Optionally, the step of mining a social business characteristic user in some of the candidate users according to the first social attribute data includes:

extracting, from the first social attribute data of the candidate users, a social business message related to service processing; and

identifying the social business characteristic user by using the social business message.

Optionally, the step of identifying the social business characteristic user by using the social business message includes:

identifying the social business characteristic user by using the social business message according to graph calculation.

Optionally, the step of training a classifier by using the second social attribute data and the second business object attribute data of the social business characteristic user includes:

selecting, from the first social attribute data and the first business object attribute data of the candidate users, first social business feature data and first business object feature data that represent service processing;

extracting, from the second social attribute data and the second business object attribute data of the social business characteristic user, second social business feature data and second business object feature data of the same type as the first social business feature data and the first business object feature data; and

training the classifier by using the second social business feature data and the second business object feature data.

Optionally, the step of training a classifier by using the second social attribute data and the second business object attribute data of the social business characteristic user further includes:

performing feature transformation on the second social business feature data and the second business object feature data of the social business characteristic user;

wherein the feature transformation includes one or more of the following:

mean transformation, variance transformation, slope transformation, and transformation of the number of crests and troughs.

Optionally, the step of training a classifier by using the second social attribute data and the second business object attribute data of the social business characteristic user further includes:

calculating a similarity between the first business object feature data of the neighboring user and the first business object feature data of the social business characteristic user; and

merging the first business object feature data of the neighboring user with the first business object feature data of the social business characteristic user when the similarity is greater than a preset similarity threshold.

Optionally, the step of selecting, from the first social attribute data and the first business object attribute data of the candidate users, first social business feature data and first business object feature data that represent service processing includes:

extracting, from the first social attribute data and the first business object attribute data of the candidate users, first social business candidate data and first business object candidate data related to the service processing;

sorting the first social business candidate data and the first business object candidate data according to importance;

searching for a selection rule of an industry to which the candidate users belong; and

selecting, in the sorted first social business candidate data and first business object candidate data, first social business feature data and first business object feature data that satisfy the selection rule.

Optionally, the step of inputting first social attribute data and first business object attribute data of a neighboring user to the classifier, and outputting a result of whether the neighboring user, in a period of time after the first period of time, is a social business characteristic user includes:

inputting the first social business feature data and the first business object feature data of the neighboring user to the classifier, and outputting the result of whether the neighboring user, in a period of time after the first period of time, is a social business characteristic user.

Optionally, the step of inputting first social attribute data and first business object attribute data of a neighboring user to the classifier, and outputting a result of whether the neighboring user, in a period of time after the first period of time, is a social business characteristic user further includes:

performing feature transformation on the first social business feature data and the first business object feature data of the neighboring candidate user;

wherein the feature transformation includes one or more of the following:

mean transformation, variance transformation, slope transformation, and transformation of the number of crests and troughs.

The example embodiments of the present disclosure further disclose a device for identifying a social business characteristic user, which includes:

a user data acquisition module that acquires user data of candidate users, wherein the user data includes first social attribute data and first business object attribute data associated in a first period of time, and second social attribute data and second business object attribute data associated in a second period of time, and the second period of time is in a period of time prior to the first period of time;

a social business characteristic user mining module that mines a social business characteristic user in some of the candidate users according to the first social attribute data;

a classifier training module that trains a classifier by using the second social attribute data and the second business object attribute data of the social business characteristic user; and

a social business characteristic user identification module that inputs first social attribute data and first business object attribute data of a neighboring user to the classifier, and outputs a result of whether the neighboring user, in a period of time after the first period of time, is a social business characteristic user, wherein the neighboring user is a candidate user other than the social business characteristic user.

Optionally, the social business characteristic user mining module includes:

a social business message extraction sub-module that extracts, from the first social attribute data of the candidate users, a social business message related to service processing; and

a user identification sub-module that identifies the social business characteristic user by using the social business message.

Optionally, the user identification sub-module includes:

a graph calculation unit that identifies the social business characteristic user by using the social business message according to graph calculation.

Optionally, the classifier training module includes:

a feature data selection sub-module that selects, from the first social attribute data and the first business object attribute data of the candidate users, first social business feature data and first business object feature data that represent service processing;

a feature data extraction sub-module that extracts, from the second social attribute data and the second business object attribute data of the social business characteristic user, second social business feature data and second business object feature data of the same type as the first social business feature data and the first business object feature data; and

a data training sub-module that trains the classifier by using the second social business feature data and the second business object feature data.

Optionally, the classifier training module further includes:

a first feature transformation sub-module that performs feature transformation on the second social business feature data and the second business object feature data of the social business characteristic user;

wherein the feature transformation includes one or more of the following:

mean transformation, variance transformation, slope transformation, and transformation of the number of crests and troughs.

Optionally, the classifier training module further includes:

a similarity calculation sub-module that calculates a similarity between the first business object feature data of the neighboring user and the first business object feature data of the social business characteristic user; and

a data merging sub-module that merges the first business object feature data of the neighboring user with the first business object feature data of the social business characteristic user when the similarity is greater than a preset similarity threshold.

Optionally, the feature data selection sub-module includes:

a candidate data extraction unit that extracts, from the first social attribute data and the first business object attribute data of the candidate users, first social business candidate data and first business object candidate data related to the service processing;

a sorting unit that sorts the first social business candidate data and the first business object candidate data according to importance;

a selection rule searching unit that searches for a selection rule of an industry to which the candidate users belong; and a data selection unit that selects, in the sorted first social business candidate data and first business object candidate data, first social business feature data and first business object feature data that satisfy the selection rule.

Optionally, the social business characteristic user identification module includes:

a data input sub-module that inputs the first social business feature data and the first business object feature data of the neighboring user to the classifier, and output the result of whether the neighboring user, in a period of time after the first period of time, is a social business characteristic user.

Optionally, the social business characteristic user identification module further includes:

a second feature transformation sub-module, that performs feature transformation on the first social business feature data and the first business object feature data of the neighboring candidate user;

wherein the feature transformation includes one or more of the following:

mean transformation, variance transformation, slope transformation, and transformation of the number of crests and troughs.

The example embodiments of the present disclosure include at least the following advantages:

The example embodiments of the present disclosure train a classifier by using second social attribute data and second business object attribute data of a social business characteristic user in a second period of time; input, to the classifier, first social attribute data and first business object attribute data of a neighboring user in a first period of time; and predict a result of whether the neighboring user, after a period of time, is a social business characteristic user. Identification is performed by using associated social attribute data and business object attribute data, which increases the volume of associated data, and improves the accuracy of the classifier, thus improving the accuracy of identification. In addition, by training the classifier with data in the second period of time, the classifier identifies potential social business characteristic users in the first period of time.

### BRIEF DESCRIPTION OF THE DRAWINGS

FIG. 1 is a flow chart of an example method for identifying a social business characteristic user according to the present disclosure; and

FIG. 2 is a structural block diagram of an example device for identifying a social business characteristic user according to the present disclosure.

### DETAILED DESCRIPTION

To make the foregoing objectives, features, and advantages of the present disclosure more comprehensible, the present disclosure is described in further detail below with reference to the accompanying drawings and example embodiments.

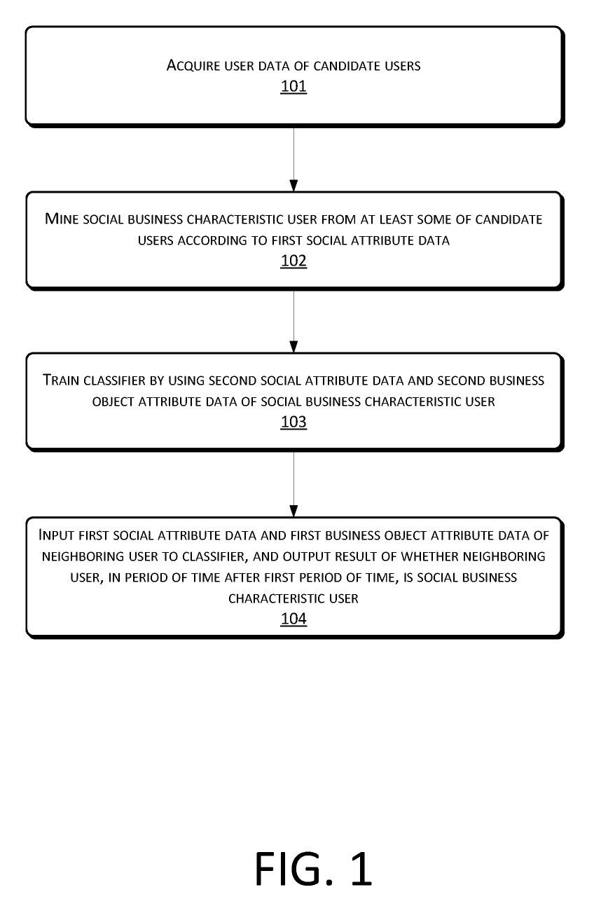

Referring to FIG. 1, FIG. 1 shows a flow chart of an example method for identifying a social business characteristic user according to the present disclosure. The method may include the following steps:

Step 101: User data of candidate users is acquired.

In an implementation, the example embodiment of the present disclosure may be applied to a cloud computing platform, that is, a server cluster, such as a distributed system, which stores business objects of massive users. In addition, the cloud computing platform may interconnect with social networks (such as Weibo™, forum, and blog), that is, the same user has business objects and social networks.

In the example embodiment of the present disclosure, the candidate user is relative to the identification of the social business characteristic user. The candidate user is also a user essentially, and is represented on the cloud computing platform by using a user identifier, that is, information that can represent a uniquely determined candidate user, including a user ID (Identity), a cookie, a Mac (Media Access Control) address, or the like.

In the example embodiment of the present disclosure, the cloud computing platform may record user data via website logs, and store the user data in a database.

The user data may include social attribute data, that is, data generated in a social network. For the example of Weibo™, the social attribute data includes personal data, fans data, status data, forwarding data, like data, and so on.

In addition, the user data may further include business object attribute data, that is, data generated when a business object carries out service processing.

It should be noted that, in different fields, there may be different business objects, that is, data reflecting characteristics of the fields.

For example, in the communications field, the business object may be communication data; in the news media field, the business object may be news data; in the search field, the business object may be a webpage; in the Electronic Commerce (EC) field, the business object may be shop data, and so on.

In different fields, although business objects are different due to different field characteristics they carry, essentially they are all data, for example, text data, image data, audio data, video data and so on, and accordingly, processing of business objects is essentially data processing.

To help persons skilled in the art better understand the example embodiment of the present disclosure, in the example embodiment of the present disclosure, shop data is used as an example of business object for description.

In this example, service processing is marketing, that is, the business object attribute data includes basic data of a shop (such as star rating of the shop, how long the shop has been open, and transactions of the shop), buyer feature data (such as the age and gender of the buyer), commodity feature data (such as commodity picture quality, commodity price, and commodity comments), behavior data (such as bookmarking, browsing, purchasing, and ordering) and the like.

Because the web site generally records user data continuously, which has a relatively long time span, the user data is generally stored in the form of database sharding.

In the example embodiment of the present disclosure, user data in two periods of time, which are a first period of time and a second period of time respectively, is selected, and the second period of time is in a period of time prior to the first period of time.

For example, if the first period of time is September 2015, the second period of time may be from September 2014 to August 2015, there is an interval of one year from the starting time of the second period of time to the starting time of the first period of time.

For the user data, the user data may include first social attribute data and first business object attribute data associated in the first period of time, and second social attribute data and second business object attribute data associated in the second period of time.

The first business object attribute data and the second business object attribute data are data generated when a business object carries out service processing.

Step 102: A social business characteristic user is mined from at least some of the candidate users according to the first social attribute data.

In the example embodiment of the present disclosure, some candidate users may be selected in advance from all candidate users, which may be manually selected or may be filtered according to a preset condition. This is not limited in the example embodiment of the present disclosure.

The social business characteristic user that represents the service processing, that is, a user who is good at using social intercourse to facilitate service processing, may be mined from the selected candidate users as a training sample of the classifier.

In the electronic commerce field, the service processing is marketing, and then the social business characteristic user may be referred to as a social marketing talent, that is, a user who is good at using social intercourse to facilitate marketing.

In an example embodiment of the present disclosure, step 102 may include the following sub-steps:

At a first sub-step: A social business message related to service processing is extracted from the first social attribute data of the candidate user.

In a specific implementation, data of the candidate users may be filtered with reference to the description of the social network, and, in general, social business characteristic users (such as social marketing talents) are mostly famous certified users, such as celebrities, designers, or forum moderators, and may have relatively obvious social characteristics.

For example, a message about service processing, such as a new product launch message or a new product trial message, is selected by text mining from social business messages related to the service processing (such as marketing) such as Weibo™ messages, fiend circle messages, forum posts, blog posts and other messages.

At a second sub-step: The social business characteristic user is identified by using the social business message.

In a specific implementation, the social business characteristic user may be identified by using the social business message according to graph calculation. By graph calculation such as PageRank, “opinion leaders”, that is, users who have a lot of service interactions with ordinary users, in the social network are found, and these users are sorted, to select top N candidate users, thus identifying whether the N candidate users are social business characteristic users.

In addition to the graph calculation, other methods may be employed to identify the social business characteristic user, which is not limited in the example embodiment of the present disclosure.

Certainly, to identify the social business characteristic user more precisely, specialized technical personnel may be employed for manual auditing, to improve the accuracy of the classifier.

Step 103: A classifier is trained by using the second social attribute data and the second business object attribute data of the social business characteristic user.

In an implementation, it may be defined that after a period of time t from the starting time of the second period of time, in the first period of time, a user becomes a social business characteristic user (such as a social marketing talent).

By using the second social attribute data and the second business object attribute data of the social business characteristic user as positive samples and the second social attribute data and second business object attribute data of non-social business characteristic users as negative samples, the classifier is trained via machine learning.

In an example embodiment of the present disclosure, step 103 may include the following sub-steps:

At a first sub-step: First social business feature data and first business object feature data that represent service processing are selected from the first social attribute data and the first business object attribute data of the candidate users.

In the example embodiment of the present disclosure, the first social business feature data and the first business object feature data that can best represent the talent are screened out from the massive first social attribute data and first business object attribute data.

In a specific implementation, first social business candidate data and first business object candidate data related to the service processing are extracted from the first social attribute data and the first business object attribute data of the candidate users by using service logic, to form a data pool.

For the example of the electronic commerce, sellers need to interact with buyers, and thus need to launch new products constantly, while the buyers would bookmark these shops to make sure they do not miss new products. In addition, these shops habitually sell as many goods as they stock, thus having a high sales rate. Therefore, the talents will have features such as a higher sales rate, a greater number of new products, and a greater number of bookmarks. Talent-related features such as the sales rate, the number of new products, and the number of buyer bookmarks may be screened out from massive data.

The first social business candidate data and the first business object candidate data may be sorted according to the importance by using a feature selection method such as ROC or related coefficients in machine learning.

Because different industries have different characteristics, for example, women's cloth talents in the women's cloth industry circle and men's cloth talents in the men's cloth industry circle have different characteristics, the importance is also different. Therefore, a selection rule of an industry to which the candidate users belong may be found.

First social business feature data and first business object feature data that meet the selection rule are selected from the sorted first social business candidate data and first business object candidate data.

The importance of features is quantitative data. Thus, a threshold may be defined, and features are screened by using a selection rule such as the importance is greater than 0.7 and less than 0.9.

At a second sub-step: Second social business feature data and second business object feature data of the same type as the first social business feature data and the first business object feature data are extracted from the second social attribute data and the second business object attribute data of the social business characteristic user.

Because the second social attribute data and the second business object attribute data in the second period of time are used as training samples, the second social business feature data and second business object feature data of the same type as the screened features may be extracted.

At a third sub-step: A similarity between the first business object feature data of the neighboring user and the first business object feature data of the social business characteristic user is calculated.

At a fourth sub-step: The first business object feature data of the neighboring user is merged with the first business object feature data of the social business characteristic user when the similarity is greater than a preset similarity threshold.

In a scenario wherein the specialized technical personnel manually audits whether the candidate user is a social business characteristic user, there may be a relatively small number of social business characteristic users, for example, 100. Therefore, the number of samples of social business characteristic users may be expanded, to prepare for identification.

In the expansion of social business characteristic users, after the first business object feature data is normalized by using similarity filtering, a similarity between first business object feature data of a neighboring user and a social business characteristic user is calculated pairwise, and a similarity threshold is set to remove non-similar first business object feature data; a result after the merging of the first business object feature data is the expanded first business object feature data.

By using the transactions and bookmarks of electronic commerce shops as an example:

| seller_id | Number of transactions | Number of bookmarks |
|---|---|---|
| 1001 | 10000 | 100 |
| 1002 | 20000 | 300 |

The number of transactions and the number of bookmarks are normalized into an interval of 0 to 1, that is:

| seller_id | Number of transactions | Number of bookmarks |
|---|---|---|
| 1001 | 0.33 | 0.25 |
| 1002 | 0.66 | 0.75 |

By using a cosine formula (included angle cosine), a similarity between the two sellers 1001 and 1002 is:

(0.33*0.66+0.25*0.75)/(SQRT(0.33̂2+0.25̂2)* SQRT(0.66̂2+0.75̂2)).

Upon acquisition, the second social business feature data and the second business object feature data may be output in the form of a list, including whether the candidate user is a social business characteristic user, feature name and value, and corresponding time.

Sample number: 1, feature 1: XXX, feature 2: XXX, . . . , feature n: XXX, talent or not: 1, time: YYYY-MM-DD

Sample number: 2, feature 1: XXX, feature 2: XXX, . . . , feature n: XXX, talent or not: 0, time: YYYY-MM-DD

Sample number: 3, feature 1: XXX, feature 2: XXX, . . . , feature n: XXX, talent or not: 1, time: YYYY-MM-DD

At a fifth sub-step: Feature transformation is performed on the second social business feature data and the second business object feature data of the social business characteristic user and the non-social business characteristic users.

Because the features screened out are features in a time sequence till the first period of time, feature transformation may be performed to make a feature wide table, wherein the feature transformation may include one or more of the following:

mean transformation, variance transformation, slope transformation, and transformation of the number of crests and troughs.

For example, the transformed features in the foregoing example may be as follows:

sample number: 1, mean of feature 1: 10, variance of feature 1: 2, slope of feature 1: 0.5, the number of crests of feature 1: 3, the number of troughs of feature 1: 5, mean of feature 2: 8, variance of feature 1: 1, slope of feature 2: 0.9, the number of crests of feature 1: 2, the number of troughs of feature 1: 7, . . . , whether the user becomes a talent after time t: 1

sample number: 1, mean of feature 1: 5, variance of feature 1: 5, slope of feature 1: 1.2, the number of crests of feature 1: 10, the number of troughs of feature 1: 8, mean of feature 2: 2, variance of feature 1: 4, slope of feature 2: 0.2, the number of crests of feature 1: 5, the number of troughs of feature 1: 3, . . . , whether the user becomes a talent after time t: 1

All the features may be converted uniformly, but the mean, variance, slope, the number of crests, and the number of troughs may be selected from different periods of time such as 7 days, 30 days, and 90 days.

At a sixth sub-step: The classifier is trained by using the second social business feature data and the second business object feature data.

By using the example embodiment of the present disclosure, a trainer may be preset for learning a logic relationship among data of different dimensions (that is, the second social attribute data and the second business object attribute data), for example, a Support Vector Machine (SVM), a Decision Tree, a Random Forest and so on, which is not limited in the example embodiment of the present disclosure.

The support vector machine maps a sample space to a high-dimension or even infinite-dimension feature space (Hilbert space) by using a non-linear mapping p, so that the non-linearly separable problem in the original sample space is converted to a linearly separable problem in the feature space.

The random forest is a forest established in a random manner. The forest is composed of a lot of decision trees, and the decision trees in the forest are not associated with each other. After the forest is obtained, when a new input sample enters, each decision tree in the forest is enabled to make a judgment separately, to see which category (corresponding to a classification algorithm) the sample belongs to; then, a category selected for the most number of times is determined, and it is predicted that the sample belongs to this category.

By constructing a decision tree on the basis that occurrence probabilities of various situations are known, a probability of an expected value of a net present value being greater than or equal to 0 is solved, to evaluate the project risk. A decision analysis method for judging the feasibility thereof is a graphical method that intuitively uses probability analysis.

Certainly, to further improve the accuracy of the classifier, multiple trainers may be simultaneously used to train classifiers, and a classifier with best performance in an offline environment is selected.

Step 104: First social attribute data and first business object attribute data of a neighboring user are input to the classifier, and a result of whether the neighboring user, in a period of time after the first period of time, is a social business characteristic user is output.

The neighboring user is a candidate user other than the social business characteristic user.

In a specific implementation, feature transformation may be performed on the first social business feature data and the first business object feature data of the neighboring candidate user.

The feature transformation may include one or more of the following:

mean transformation, variance transformation, slope transformation, and transformation of the number of crests and troughs.

The first social business feature data and the first business object feature data of the neighboring user are input to the classifier, and the result of whether the neighboring user, in a period of time after the first period of time, is a social business characteristic user is output, that is, it is predicted whether the neighboring user becomes a social business characteristic user over a period of time after the first period of time.

For the example of the electronic commerce, if data of a social marketing talent in a year before September 2015 (the first period of time) is used to train the classifier, the classifier may be used to identify whether the neighboring user becomes a social marketing talent in September 2016, and if yes, the neighboring user may be referred to as a potential social marketing talent.

Social marketing, with its powerful turnover outbreak and fans effect, rapidly becomes a rapidly growing and innovative business mode in the electronic commerce platform, and has fast-fashion and social-dependent features of the Internet.

Different from the conventional low-price marketing mode, the social marketing brings high-quality traffic and an extremely high conversion rate, and even if a product is sold at a high price, it is still sold out in time upon new arrival.

Currently, a lot of potential social marketing talents cannot carry out social operations on their own due to their weak social power. Therefore, after potential social marketing talents are identified, these potential social marketing talents may be helped to organize activities regularly in the social network. A professional agent operating mechanism is built to reduce operating costs, thus accelerating improvement of the sales volume.

The example embodiment of the present disclosure trains a classifier by using second social attribute data and second business object attribute data of a social business characteristic user in a second period of time; inputs, to the classifier, first social attribute data and first business object attribute data of a neighboring user in a first period of time; and predicts a result of whether the neighboring user, after a period of time, is a social business characteristic user. Identification is performed by using associated social attribute data and business object attribute data, which increases the volume of associated data, and improves the accuracy of the classifier, thus improving the accuracy of identification. In addition, by training the classifier by using the data in the second period of time, the classifier identifies potential social business characteristic users in the first period of time.

It should be noted that, to make the description simple, the method example embodiment is expressed as a combination of a series of actions. However, persons skilled in the art should know that the example embodiment of the present disclosure is not limited by the described action order, because, according to the example embodiment of the present disclosure, some steps may be performed in other orders or at the same time. Moreover, persons skilled in the art should also know that the example embodiments described in the specification are all examples, and the actions involved are not necessarily mandatory to the example embodiments of the present disclosure.

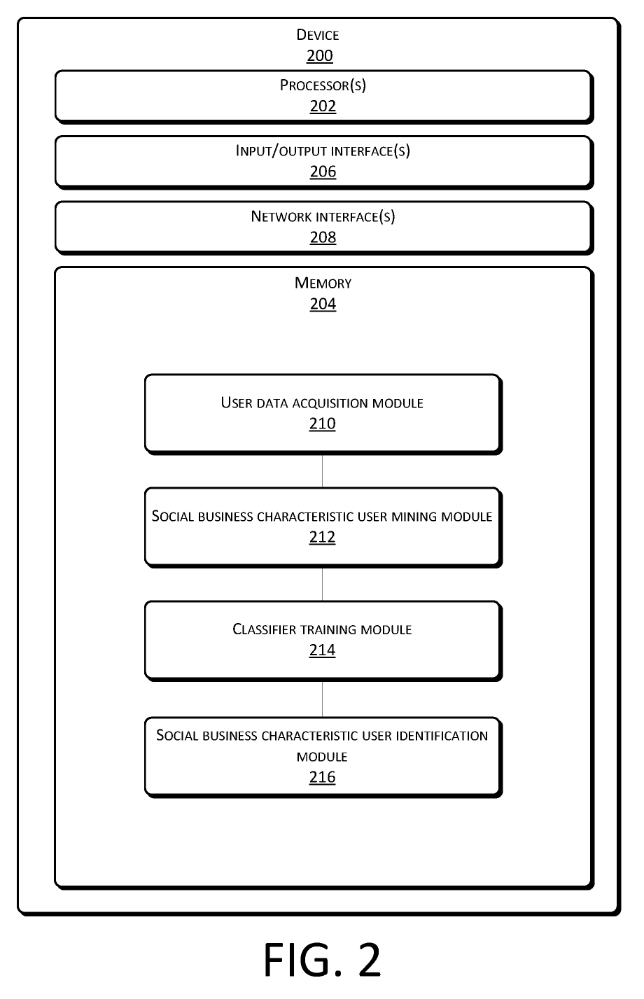

Referring to FIG. 2, FIG. 2 shows a structural block diagram of an example device 200 for identifying a social business characteristic user according to the present disclosure.

The device 200 includes one or more processor(s) 202 or data processing unit(s) and memory 204. The device 200 may further include one or more input/output interface(s) 206, and network interface(s) 208. The memory 204 is an example of computer readable media.

The memory 204 may store therein a plurality of modules or units including:

a user data acquisition module 210 that acquires user data of candidate users, wherein the user data includes first social attribute data and first business object attribute data associated in a first period of time, and second social attribute data and second business object attribute data associated in a second period of time, and the second period of time is in a period of time prior to the first period of time;

a social business characteristic user mining module 212 that mines a social business characteristic user in some of the candidate users according to the first social attribute data;

a classifier training module 214 that trains a classifier by using the second social attribute data and the second business object attribute data of the social business characteristic user; and

a social business characteristic user identification module 216 that inputs first social attribute data and first business object attribute data of a neighboring user to the classifier, and outputs a result of whether the neighboring user, in a period of time after the first period of time, is a social business characteristic user, wherein the neighboring user is a candidate user other than the social business characteristic user.

In an example embodiment of the present disclosure, the social business characteristic user mining module 212 may include the following sub-modules:

a social business message extraction sub-module that extracts, from the first social attribute data of the candidate users, a social business message related to service processing; and

a user identification sub-module that identifies the social business characteristic user by using the social business message.

In an example embodiment of the present disclosure, the user identification sub-module may include the following unit:

a graph calculation unit that identifies the social business characteristic user by using the social business message according to graph calculation.

In an example embodiment of the present disclosure, the classifier training module 214 may include the following sub-modules:

a feature data selection sub-module that selects, from the first social attribute data and the first business object attribute data of the candidate users, first social business feature data and first business object feature data that represent service processing;

a feature data extraction sub-module that extracts, from the second social attribute data and the second business object attribute data of the social business characteristic user, second social business feature data and second business object feature data of the same type as the first social business feature data and the first business object feature data; and

a data training sub-module that trains the classifier by using the second social business feature data and the second business object feature data.

In an example embodiment of the present disclosure, the classifier training module 214 may further include the following sub-modules:

a first feature transformation sub-module that performs feature transformation on the second social business feature data and the second business object feature data of the social business characteristic user, wherein the feature transformation includes one or more of the following:

mean transformation, variance transformation, slope transformation, and transformation of the number of crests and troughs.

In an example embodiment of the present disclosure, the classifier training module 214 may further include the following sub-modules:

a similarity calculation sub-module that calculates a similarity between the first business object feature data of the neighboring user and the first business object feature data of the social business characteristic user; and

a data merging sub-module that merges the first business object feature data of the neighboring user with the first business object feature data of the social business characteristic user when the similarity is greater than a preset similarity threshold.

In an example embodiment of the present disclosure, the feature data selection sub-module may include the following units:

a candidate data extraction unit that extracts, from the first social attribute data and the first business object attribute data of the candidate users, first social business candidate data and first business object candidate data related to the service processing;

a sorting unit that sorts the first social business candidate data and the first business object candidate data according to importance;

a selection rule searching unit that searches for a selection rule of an industry to which the candidate users belong; and a data selection unit that selects, in the sorted first social business candidate data and first business object candidate data, first social business feature data and first business object feature data that satisfy the selection rule.

In an example embodiment of the present disclosure, the social business characteristic user identification module 216 may include the following sub-module:

a data input sub-module that inputs the first social business feature data and the first business object feature data of the neighboring user to the classifier, and output the result of whether the neighboring user, in a period of time after the first period of time, is a social business characteristic user.

In an example embodiment of the present disclosure, the social business characteristic user identification module 216 may further include the following sub-module:

a second feature transformation sub-module that performs feature transformation on the first social business feature data and the first business object feature data of the neighboring candidate user, wherein the feature transformation includes one or more of the following:

mean transformation, variance transformation, slope transformation, and transformation of the number of crests and troughs.

The description of the device example embodiment is relatively simple because it is basically similar to the method example embodiment. References may be made to relevant description of the method example embodiment for related content.

The example embodiments in the specification are described progressively. Each example embodiment focuses on the difference from other example embodiments. For the identical or similar parts among the example embodiments, reference may be made to each other.

It should be understood by persons skilled in the art that the example embodiments of the present disclosure may be provided as a method, a device or a computer program product. Therefore, the present disclosure may employ the form of a full hardware example embodiment, a full software example embodiment or an example embodiment combining software and hardware. Moreover, the example embodiments of the present disclosure may employ the form of a computer program product that is implemented on one or more computer readable media (including, but is not limited to, magnetic disk storage, CD-ROM, optical storage, etc.) containing computer-executable instructions.

In a typical configuration, the computer device includes one or more processors (CPU), an input/output interface, a network interface, and a memory. The memory may include forms of a volatile memory, a random access memory (RAM), and/or a non-volatile memory in computer readable media, such as a read-only memory (ROM) or a flash memory (flash RAM). The memory is an example of the computer readable media. The computer readable media include permanent and temporary, and removable and non-removable media, and information may be stored by using any method or technology. The information may be a computer readable instruction, a data structure, a program module, or other data. Examples of the computer storage media include, but are not limited to, a phase change memory (PRAM), a static random access memory (SRAM), a dynamic random access memory (DRAM), other types of random access memories (RAM), a read-only memory (ROM), an electrically erasable programmable read-only memory (EEPROM), a flash memory or other memory technologies, a compact disc read-only memory (CD-ROM), a digital versatile disc (DVD) or other optical storage, a cassette-type tape, a magnetic tape, a disk storage or other magnetic storage devices or any other non-transmission media, and can be used to store information accessible to computing devices. According to the definitions in this specification, the computer readable media do not include transitory media, such as modulated data signal and carrier.

The present disclosure is described with reference to flow charts and/or block diagrams of the method, the terminal apparatus (system) and the computer program product according to the example embodiments of the present disclosure. It should be understood that computer-executable instructions may be used to implement each process and/or block in the flow charts and/or block diagrams and combinations of processes and/or blocks in the flow charts and/or block diagrams. The computer-executable instructions may be provided to a universal computer, a dedicated computer, an embedded processor or a processor of another programmable data processing terminal apparatus to generate a machine, such that the computer or a processor of another programmable data processing terminal apparatus executes an instruction to generate a device for implementing functions designated in one or more processes in a flow chart and/or one or more blocks in a block diagram.

The computer-executable instructions may also be stored in computer readable media that guide a computer or another programmable data processing terminal apparatus to work in a specific manner, such that the instruction stored in the computer readable storage generates an article of manufacture including an instruction device, the instruction device implementing functions designated by one or more processes in a flow chart and/or one or more blocks in a block diagram.

The computer-executable instructions may also be loaded in a computer or another programmable data processing terminal apparatus, such that the computer or another programmable data processing terminal apparatus executes a series of operating steps to generate processing implemented by the computer, and thus the instructions executed in the computer or another programmable data processing terminal apparatus provide steps for implementing functions as specified in one or more processes in the flow charts and/or one or more blocks in the block diagrams.

Although the example embodiments of the present disclosure have been described, other variations and modifications may be made to the example embodiments by those persons skilled in the art upon understanding of the basic inventive concepts. Therefore, the appended claims are intended to be construed as covering the example embodiments and all the variations and modifications that fall into the scope of the example embodiments of the present disclosure.

Finally, it should be noted that the relational terms such as “first” and “second” herein are only used to distinguish an entity or operation from another entity or operation, but not necessarily require or suggest there exists any real relation or sequence between the entities or operations. Moreover, terms such as “include”, “comprise” or any other variants are intended to cover a non-exclusive inclusion, so that the process, method, article or terminal apparatus containing a series of elements not only includes these elements but also includes other elements that are not expressly listed or the inherent elements of the process, method, article or terminal apparatus. Unless otherwise specified, an element defined by the wording “include a . . . ” does not exclude additional identical elements existing in the process, method, article or terminal apparatus containing this element.

A method for identifying a social business characteristic user and a device for identifying a social business characteristic user provided by the present disclosure are described in detail above. Specific examples are used herein to illustrate the principles and implementation manners of the present disclosure. The above description of the example embodiments is merely used to help to understand the method of the present disclosure and the core idea thereof. Meanwhile, persons of ordinary skill in the art may make changes to the specific implementation manners and application scope according to the thought of the present disclosure. In conclusion, the content of the specification should not be construed as a limitation to the present disclosure.

What is claimed is:

1. A method for identifying a social business characteristic user, the method comprising:
acquiring user data of candidate users, the user data including first social attribute data and first business object attribute data that are associated in a first period of time, and second social attribute data and second business object attribute data that are associated in a second period of time, the second period of time being in a period of time prior to the first period of time;
mining a social business characteristic user in at least some of the candidate users according to the first social attribute data;
training a classifier by using the second social attribute data and the second business object attribute data of the social business characteristic user;
inputting first social attribute data and first business object attribute data of a neighboring user to the classifier; and
outputting a result of whether the neighboring user, in a period of time after the first period of time, is a social business characteristic user, the neighboring user being a candidate user other than the social business characteristic user.

2. The method of claim 1, wherein the mining the social business characteristic user in at least some of the candidate users according to the first social attribute data includes:
extracting, from the first social attribute data of the candidate users, a social business message related to service processing; and
identifying the social business characteristic user by using the social business message.

3. The method of claim 2, wherein the identifying the social business characteristic user by using the social business message includes identifying the social business characteristic user by using the social business message according to a graph calculation.

4. The method of claim 1, wherein the training the classifier by using the second social attribute data and the second business object attribute data of the social business characteristic user includes:
selecting, from the first social attribute data and the first business object attribute data of the candidate users, first social business feature data and first business object feature data that represent service processing;
extracting, from the second social attribute data and the second business object attribute data of the social business characteristic user, second social business feature data and second business object feature data of a same type as the first social business feature data and the first business object feature data; and
training the classifier by using the second social business feature data and the second business object feature data.

5. The method of claim 4, wherein the training the classifier by using the second social attribute data and the second business object attribute data includes performing feature transformation on the second social business feature data and the second business object feature data of the social business characteristic user.

6. The method of claim 5, wherein the feature transformation includes one or more of the following:
mean transformation;
variance transformation;
slope transformation, and
transformation of a number of crests and troughs.

7. The method of claim 4, wherein the training the classifier by using the second social attribute data and the second business object attribute data includes:
calculating a similarity between the first business object feature data of the neighboring user and the first business object feature data of the social business characteristic user; and
merging the first business object feature data of the neighboring user with the first business object feature data of the social business characteristic user when the similarity is greater than a preset similarity threshold.

8. The method of claim 4, wherein the selecting, from the first social attribute data and the first business object attribute data of the candidate users, first social business feature data and first business object feature data that represent service processing includes:
extracting, from the first social attribute data and the first business object attribute data of the candidate users, first social business candidate data and first business object candidate data related to the service processing;
sorting the first social business candidate data and the first business object candidate data according to importance;
searching for a selection rule of an industry to which the candidate users belong; and
selecting, in the sorted first social business candidate data and first business object candidate data, first social business feature data and first business object feature data that satisfy the selection rule.

9. The method of claim 4, wherein the inputting the first social attribute data and the first business object attribute data of the neighboring user to the classifier, and outputting the result of whether the neighboring user, in the period of time after the first period of time, is the social business characteristic user includes:
inputting the first social business feature data and the first business object feature data of the neighboring user to the classifier, and outputting the result of whether the neighboring user, in a period of time after the first period of time, is a social business characteristic user.

10. The method of claim 8, wherein the inputting the first social attribute data and the first business object attribute data of the neighboring user to the classifier, and outputting the result of whether the neighboring user, in the period of time after the first period of time, is the social business characteristic user includes:
performing feature transformation on the first social business feature data and the first business object feature data of the neighboring candidate user.

11. The method of claim 10, wherein the feature transformation includes one or more of the following:
mean transformation;
variance transformation;
slope transformation; and
transformation of a number of crests and troughs.

12. One or more memories stored thereon computer-executable instructions, executable by one or more processors, to cause the one or more processors to perform acts comprising:
acquiring user data of candidate users, the user data including first social attribute data and first business object attribute data that are associated in a first period of time, and second social attribute data and second business object attribute data that are associated in a second period of time, the second period of time being in a period of time prior to the first period of time;
mining a social business characteristic user in at least some of the candidate users according to the first social attribute data;
training a classifier by using the second social attribute data and the second business object attribute data of the social business characteristic user;
inputting first social attribute data and first business object attribute data of a neighboring user to the classifier; and
outputting a result of whether the neighboring user, in a period of time after the first period of time, is a social business characteristic user, the neighboring user being a candidate user other than the social business characteristic user.

13. The one or more memories of claim 12, wherein the mining the social business characteristic user in at least some of the candidate users according to the first social attribute data includes:
extracting, from the first social attribute data of the candidate users, a social business message related to service processing; and
identifying the social business characteristic user by using the social business message.

14. The one or more memories of claim 13, wherein the identifying the social business characteristic user by using the social business message includes identifying the social business characteristic user by using the social business message according to a graph calculation.

15. The one or more memories of claim 12, wherein the training the classifier by using the second social attribute data and the second business object attribute data of the social business characteristic user includes:
selecting, from the first social attribute data and the first business object attribute data of the candidate users, first social business feature data and first business object feature data that represent service processing;
extracting, from the second social attribute data and the second business object attribute data of the social business characteristic user, second social business feature data and second business object feature data of a same type as the first social business feature data and the first business object feature data; and
training the classifier by using the second social business feature data and the second business object feature data.

16. The one or more memories of claim 15, wherein the training the classifier by using the second social attribute data and the second business object attribute data includes performing feature transformation on the second social business feature data and the second business object feature data of the social business characteristic user,
wherein the feature transformation includes one or more of the following:
mean transformation;
variance transformation;
slope transformation; and
transformation of a number of crests and troughs.

17. The one or more memories of claim 15, wherein the training the classifier by using the second social attribute data and the second business object attribute data includes:
calculating a similarity between the first business object feature data of the neighboring user and the first business object feature data of the social business characteristic user; and
merging the first business object feature data of the neighboring user with the first business object feature data of the social business characteristic user when the similarity is greater than a preset similarity threshold.

18. The one or more memories of claim 15, wherein the selecting, from the first social attribute data and the first business object attribute data of the candidate users, first social business feature data and first business object feature data that represent service processing includes:
extracting, from the first social attribute data and the first business object attribute data of the candidate users, first social business candidate data and first business object candidate data related to the service processing;
sorting the first social business candidate data and the first business object candidate data according to importance;
searching for a selection rule of an industry to which the candidate users belong; and
selecting, in the sorted first social business candidate data and first business object candidate data, first social business feature data and first business object feature data that satisfy the selection rule.

19. The one or more memories of claim 15, wherein the inputting the first social attribute data and the first business object attribute data of the neighboring user to the classifier, and outputting the result of whether the neighboring user, in the period of time after the first period of time, is the social business characteristic user includes:
inputting the first social business feature data and the first business object feature data of the neighboring user to the classifier, and outputting the result of whether the neighboring user, in a period of time after the first period of time, is a social business characteristic user.

20. A device for identifying a social business characteristic user, the device comprising:
a user data acquisition module that acquires user data of candidate users, wherein the user data comprises first social attribute data and first business object attribute data associated in a first period of time, and second social attribute data and second business object attribute data associated in a second period of time, and the second period of time is in a period of time prior to the first period of time;
a social business characteristic user mining module that mines a social business characteristic user in at least some of the candidate users according to the first social attribute data;
a classifier training module, that trains a classifier by using the second social attribute data and the second business object attribute data of the social business characteristic user; and
a social business characteristic user identification module, that inputs first social attribute data and first business object attribute data of a neighboring user to the classifier, and output a result of whether the neighboring user, in a period of time after the first period of time, is a social business characteristic user, wherein the neighboring user is a candidate user other than the social business characteristic user.
